(19) United States
(12) Patent Application Publication
(10) Pub. No.: US 2025/0138820 A1
(43) Pub. Date: May 1, 2025

(54) MODEL-SPECIFIC ASIC COMPILATION USING FUSED KERNEL REPLACEMENT

(71) Applicant: Etched.ai, Inc., Menlo Park, CA (US)

(72) Inventors: Tom SHLOMI, Menlo Park, CA (US); Gavin UBERTI, Menlo Park, CA (US)

(21) Appl. No.: 18/384,023

(22) Filed: Oct. 26, 2023

(51) Int. Cl. G06F 8/76

(52) U.S. Cl. CPC G06F 8/76

(57) ABSTRACT

Embodiments herein describe translating specialized functions for one type of hardware platform into executable code for a different type of hardware platform. For example, a specialized function developed for a first hardware platform (e.g., a GPU or CPU) can be translated into an intermediate representation (IR) containing arguments for a second hardware platform (e.g., a model-specific chipset) by a compiler. The compiler can then convert the IR into executable code for the second hardware platform.

### TECHNICAL FIELD

Embodiments presented in this disclosure generally relate to translating specialized functions for one type of hardware platform into executable code for a different type of hardware platform.

### BACKGROUND

AI models are typically written using functions from a machine learning (ML) or artificial intelligence (AI) framework such as PyTorch (PyTorch is a trademark of The Linux Foundation) or TensorFlow (TensorFlow is a trademark of Google Inc.). Often, an AI model performs multiple functions in these frameworks sequentially, such as performing an activation after performing a matrix multiplication. Rather than performing one operation (e.g., matrix multiplication), storing the results in memory, and then reading the results from memory to perform a second operation (e.g., the activation), it would be more efficient to perform the operations sequentially using a fused kernel. Thus, sequential operations can be executed using a fused kernel on a hardware platform (e.g., a central processing unit (CPU) or a graphics processing unit (GPU).

Some types of AI models, such as transformer models (also referred to as just a “transformer”) have primarily (or solely) sequential operations. Instead of a compiler having to identify operations to fuse into a kernel, some hardware platform providers have created specialized functions that are a layer above the functions of the AI framework. These specialized functions can represent a combination of some of functions of the AI framework. When compiling AI software code with these specialized functions, the specialized functions are converted into code that is optimized for the hardware platform. However, difficulties arise when AI model code includes specialized functions for a first type of hardware platform but the customer wishes to execute the AI model of second, different type of hardware platform.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a workflow for creating an AI model, according to one embodiment.

FIG. 2 is a flowchart for creating an AI model, according to one embodiment.

FIG. 3 is a flowchart for translating a specialized function into an intermediate representation for a model-specific chipset, according to one embodiment.

FIG. 4 illustrates a portion of an exemplary intermediate representation specification, according to one embodiment.

FIG. 5 is a flowchart for translating specialized functions for a first-type of chipset into executable code for a model-specific chipset, according to one embodiment.

FIG. 6 illustrates an integrated circuit with a systolic array and a self-attention circuit, according to one embodiment.

FIG. 7 illustrates a package with a combined systolic array formed using a plurality of integrated circuits, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### SUMMARY

One embodiment presented in this disclosure is a method that includes receiving artificial intelligence (AI) model code containing a specialized function for a first one or more types of hardware platforms and converting, by a compiler, the specialized function into executable code for a second type of hardware platform.

Another embodiment disclosed herein is a non-transitory computer readable medium having program instructions embodied therewith, the program instructions executable by a processor to perform an operation. The operation includes receiving AI model code containing a specialized function for a one or more types of hardware platforms, translating, by a compiler, the specialized function into an IR, and converting, by the compiler, the IR into executable code for a second type of hardware platform.

Another embodiment disclosed herein is a system that includes one or more processors and memory storing a compiler which, when executed by the one or more processors, performs an operation. The operation includes receiving AI model code containing a specialized function for a first one or more types of hardware platforms, translating the specialized function into an IR, and converting the IR into executable code for a second type of hardware platform.

### DETAILED DESCRIPTION

Embodiments herein describe translating specialized functions for one or more types of hardware platform (e.g., GPUs) into executable code for a different type of hardware platform. As an example, some hardware platform providers have generated specialized functions that correspond to fused kernels when compiled. That is, the hardware providers can provide special code that, when compiled, generate fused kernels on the hardware platforms. As discussed above, these fused kernels have several advantages when it comes to efficiency and reducing memory read/writes.

For transformer models which rely primarily on sequential operations, there can be a few specialized operations (e.g., less than ten) that define almost every operation performed by these models. Thus, a complexity of a compiler can be greatly reduced if it primarily supports these specialized operations rather than the full range of functions offered by a typical AI framework such as PyTorch and TensorFlow (which can include hundreds of functions). Put differently, a compiler that primarily supports specialized functions used by transformer models (and a handful of other non-specialized functions in an AI framework such as the dropout function in PyTorch) can be much simpler to develop compared to a compiler that supports all the function in the AI framework and must search for functions that can be combined into fused kernels.

Since some hardware providers have already developed specialized functions that generate fused kernels for transformer models, one or more of the embodiments herein can leverage those specialized functions by translating them into code for a different hardware platform. For example, one specialized function performs a layer normalization followed by a linear transformation, but the code corresponding to this specialized function may be developed for a first type of hardware platform (e.g., a GPU). In one embodiment, the AI model developer may call this specialized function so the AI model can be trained on the GPU. However, inference may be performed on a second type of hardware platform (e.g., a specialized chipset that is designed for executing only transformer models). Rather than requiring the developer to write different code for the two types of hardware platforms, the specialized functions used by the first type of hardware platform can be translated into executable code for the second type of hardware platform. This can be performed using an intermediate representation (IR) where the parameters for the specialized function are translated into an IR for the second type of hardware platform. This IR is then converted into executable code (e.g., assembly language) for the second type of hardware platform. In this manner, specialized functions that generate fused kernels in a first hardware platform (e.g., a CPU or GPU) can be translated and used to generate fused kernels in a second hardware platform (e.g., a transformer model specific chipset). The code can be primarily limited to these higher-level specialized functions, which greatly reduces the complexity of the compiler.

While the embodiments herein describe a transformer model specific chip as a specific example, they are not limited to such. The embodiments herein can be used to translate specialized functions for one hardware platform into any type of model-specific ASIC or chipset. Further, as used herein, a “chipset” can include only one IC (e.g., only one ASIC or GPU) or multiple ICs (e.g., multiple ASICs or GPUs).

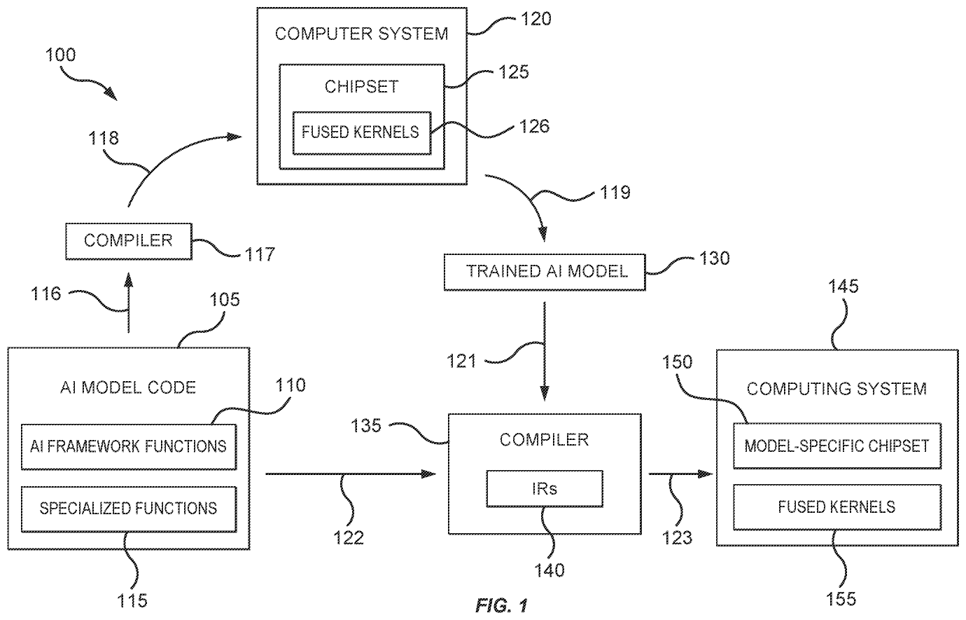

FIG. 1 illustrates a workflow 100 for creating an AI model, according to one embodiment. The workflow 100 starts when a developer provides AI model code 105, which can be written in any suitable high-level software programming language-e.g., Python, C, C++, etc. In this embodiment, the AI model code 105 includes AI framework functions 110 and specialized functions 115. The AI framework functions 110 can be functions defined in PyTorch, TensorFlow, or any other AI framework. The embodiments herein are not limited to using any particular AI or ML framework.

The specialized functions 115 can be thought of as a higher layer of abstraction than the AI framework functions 110. Put differently, the specialized functions 115 can be a combination of the AI framework functions. For example, the AI framework can establish a first function for performing layer normalization and a second function for performing a linear transformation. Instead, the specialized function 115 can be one function that applies layer normalization to the input followed by a linear transformation.

Another example of a specialized function 115 can be one that applies layer normalization on the input followed by a Multi-layer Perceptron (MLP) module. This specialized function 115 can also include two successive linear transformations that are separated by a Gaussian error Linear Unit (GeLU) activation. In this manner, a specialized function can include the combination of functions in an AI framework that are executed sequentially and in a particular order.

Specialized functions 115 can be developed by a hardware platform provider for different kinds of AI models, such as a transformer model. The provider can provide code corresponding to the specialized functions that generate fused kernels on the hardware platform that perform the various lower-level functions defined in the specialized functions 115. This makes it easier for a compiler, since it does not have to find and fuse kernels, but rather simply compile the code corresponding to the specialized functions 115.

As shown by arrow 116, the AI model code 105 is first sent to a compiler 117. In one embodiment, the compiler 117 is designed to recognize the AI framework functions 110 and the specialized functions 115. For example, the compiler 117 may be provided by a first hardware platform provider who provides the chipset 125 (e.g., a first type of hardware platform). The first hardware platform provider can provide the compiler 117 and define the specialized functions 115 as an optimization to the software developer so the AI model code 105 has optimized performance when executed on the chipset 125.

When compiling the AI model code 105, the compiler 117 may have pre-defined code for the specialized functions 115. For example, the pre-defined code can be developed by the first hardware platform provider so that the individual functions of the AI framework that are in each of the specialized functions 115 are combined into a fused kernel 126 on the chipset 125. In this manner, the specialized functions 115 provide a higher-level construct than the AI framework functions 110. This higher-level construct can be easier for a user to use to optimize the execution of the AI model on the chipset 125.

As discussed above, the first hardware platform provider may define a limited number of specialized functions 115 (e.g., ten or less). However, for some models, such as transformer models, this may be essentially all the functions that are needed to execute the model. This is one advantage of transformer models since the different functions or layers are typically executed sequentially and in a particular order, making them well-suited for developing a handful of specialized functions 115.

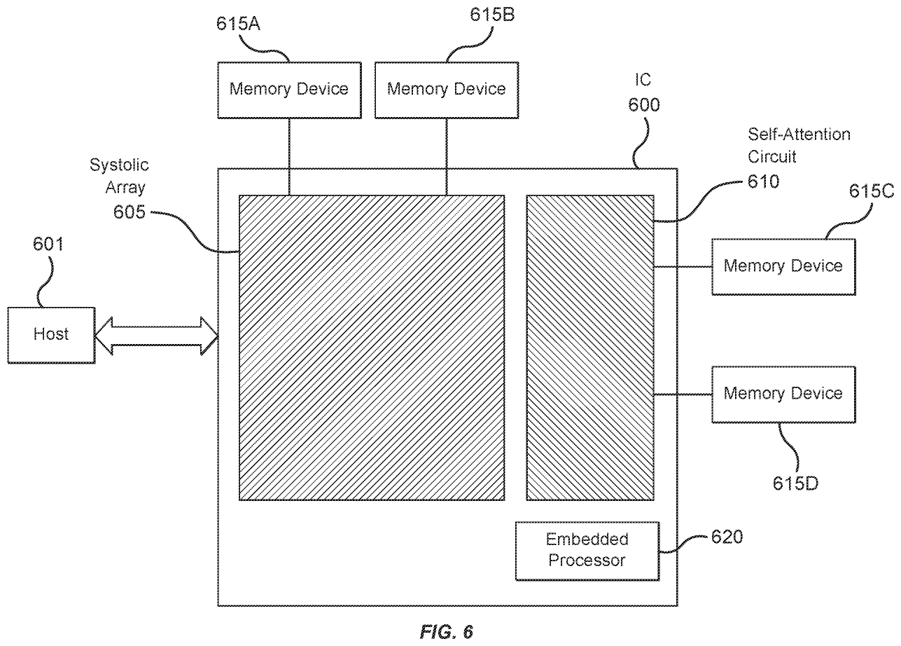

After compilation, executable code is sent to a computing system 120 as shown by the arrow 118. The computing system 120 executes the AI model using the chipset 125. The chipset 125 can be a single IC (e.g., one CPU or GPU) or multiple ICs (e.g., multiple CPUs and GPUs). In the workflow 100, the developer uses the chipset 125 to train the AI model but uses a model-specific chipset 150 to perform inference using the trained AI model. That is, the chipset 125 may not be a model-specific hardware platform, which means it can execute different types of AI models. In contrast, the chipset 150 is model specific which means it is optimized to execute only one type of AI model (or a very limited number of different types of AI models). For example, the chipset 150 may be designed or optimized to execute only transformer models but could execute other types of AI models although there is loss in efficiency. For instance, the chipset 150 may be able to run a standard deep neural network by not using a self-attention unit in the chipset 150 (e.g., a self-attention circuit 610 discussed in FIG. 6 below). The chipset 150 may also be able to execute AI networks with convolution layers although it may do so inefficiently relative to other hardware platforms (e.g., CPUs or GPUs).

Further, in one embodiment, the model-specific chipset 150 may not be able to train the AI model. As such, the workflow 100 relies on the non-model specific chipset 125 to train the AI model. However, in other embodiments, a model-specific chipset 150 may be able to perform both training and inference.

As discussed above, the chipset 125 includes fused kernels 126 that correspond to the specialized functions 115 in the AI model code 105. In addition, the compiler 117 may have also combined some of the AI framework functions 110 to create additional fused kernels 126, which may be different than the fused kernels 126 defined by the specialized functions 115, but this is not a requirement.

As shown by arrow 119, the computing system 120 outputs a trained AI model 130. The embodiments herein are not limited to any particular type of training technique. For example, the training technique may depend on the type of the AI model 130.

As shown by arrows 121 and 122, the trained AI model 130 and the AI model code 105 is received by a compiler 135. While the compiler 117 discussed above may have been developed by the first hardware platform provider who provides the chipset 125, the compiler 135 may be developed by a second hardware platform provider who provides the model-specific chipset 150. Further, the compiler 117 may be executed in the computing system 120 (or in a separate computing system) and the compiler 135 may be executed in the computing system 145 (or in a separate computing system).

The second hardware platform provider may also want to support the specialized functions 115 that resulted in the fused kernels 126 in the chipset 125. Providing a compiler 135 that supports the limited number of specialized functions 115 may be much simpler to develop than one that supports all the Ai framework functions 110. Thus, the second hardware platform provider may tell the developer that its compiler 135 supports the specialized functions 115 as well as a few of the AI framework functions 110, but does not support many of the other AI framework functions. For example, the compiler 135 may support the same specialized functions 115 defined by the first hardware platform provider but only a limited number of the functions defined in PyTorch or TensorFlow. However, for some types of AI models (e.g., transformer models), this limited set of AI framework functions 110 and specialized functions 115 may be sufficient to perform a wide variety of AI tasks.

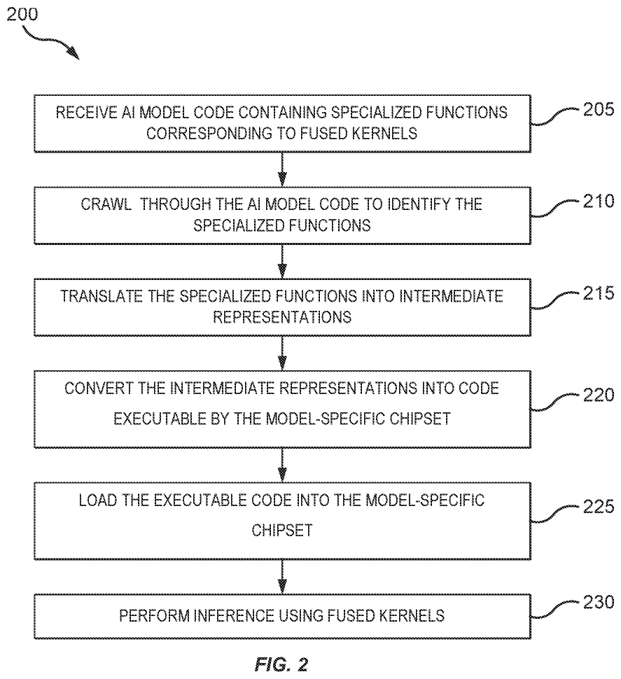

The compiler 135 can include IRs 140 for the specialized functions. As discussed above, the compiler 117 may use specific code to compile the specialized functions 115 that is optimized for the chipset 125. For example, the compiler 117 may have predefined code (e.g., compute unified device architecture (CUDA) code) that it compiles for each of the specialized functions 115. However, the model-specific chipset 150 may have very different hardware/circuitry from the chipset 125, and thus, this predefined code cannot be used by the compiler 135. Instead of the compiler 135 substituting in predefined code for the specialized functions during compilation, the compiler 135 translates the specialized functions 115 into IRs 140 that provide values of arguments that configure the model-specific chipset 150 to perform the operations defined in the specialized functions 115. For instance, the compiler 135 may generate a respective IR 140 for each of the specialized functions 115 defined by the first hardware platform provider. After converting the specialized functions 115 into the IRs 140, the compiler 135 then generates executable code from the IRs 140. The process of translating the specialized functions 115 into the IRs 140 is discussed in more detail in FIGS. 2-5 below.

After compiling the AI model code 105, executable code is provided to the computing system 145 as shown by the arrow 123. The executable code establishes the fused kernels 155. For example, each of the specialized functions 115 may correspond to a fused kernel 155 in the model-specific chipset 150. The AI model is then executed on the chipset 150 using the fused kernels 155 (and potentially other un-fused kernels).

FIG. 2 is a flowchart of a method 200 for creating an AI model, according to one embodiment. At block 205, a compiler (e.g., the compiler 135 in FIG. 1) receives AI model code containing specialized functions corresponding to fused kernels. In one embodiment, the specialized functions are defined by a first hardware platform provider, but are being compiled by a compiler developed by a second hardware platform provider so the AI model can be executed on a different chipset (e.g., a model-specific chipset). For example, before block 205, the specialized functions may have been first compiled using a compiler developed by the first hardware platform provider to perform, e.g., training, but this is not a requirement. In any case, the method 200 describes techniques for translating specialized functions defined by a first hardware platform provider for use by a chipset provided by a second hardware platform provider.

At block 210, the compiler crawls through the AI model code to identify the specialized functions. For example, the compiler may iterate through the different functions in the AI model code to identify the specialized functions.

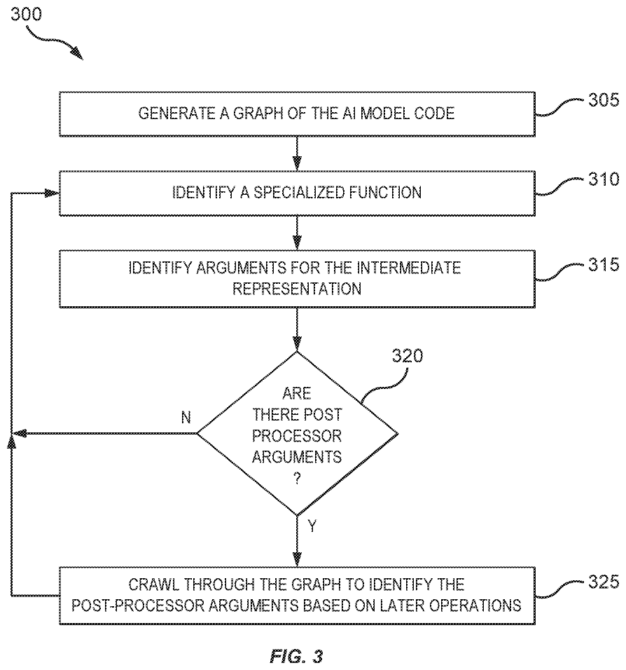

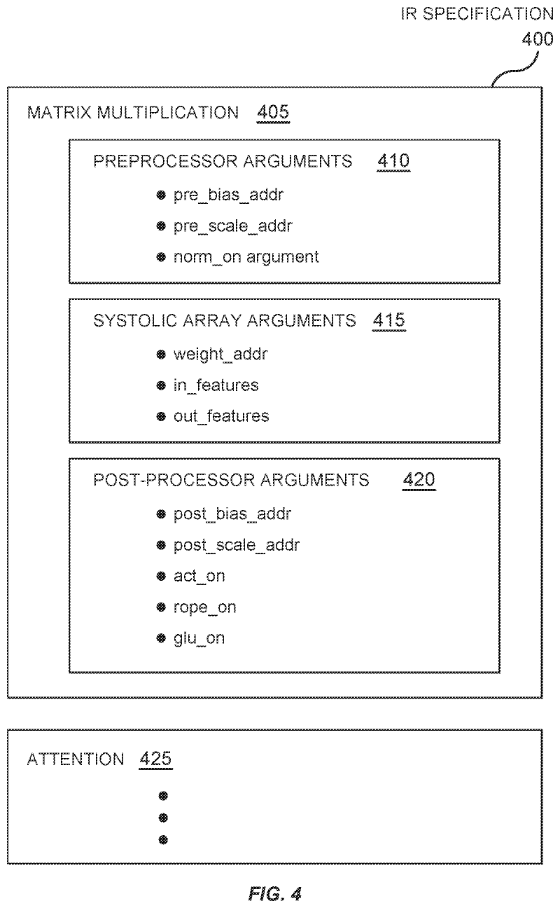

At block 215, the compiler translates the specialized functions into IRs (e.g., the IRs 140 in FIG. 1). In one embodiment, the compiler generates an IR for each of the specialized functions defined by the first hardware platform provider. The IRs can provide arguments or parameters that are needed in order to perform the operations in the specialized functions in the model-specific chipset. Translating the specialized functions into IRs is discussed in more detail in FIGS. 3 and 4.

At block 220, the compiler converts the IRs into code executable by the model-specific chipset provided by the second hardware platform provider. For example, the executable code can include assembly code that is executable by a processor in the chipset.

At block 225, the compiler loads the executable code into the model-specific chipset. In one embodiment, the model-specific chipset includes an embedded processor that receives the executable code. The embedded processor can then configure the circuitry in the model-specific chipset to execute the AI model. For example, the embedded processor can load the fused kernels into the chipset.

At block 230, the model-specific chipset performs inference using the fused kernels. In this manner, specialized functions that may not be defined by the hardware platform provider of the model-specific chipset can nonetheless be translated into executable code for the model-specific chip. For example, a developer can write AI model code that includes specialized functions that can be executed on two different types of chipsets.

FIG. 3 is a flowchart of a method 300 for translating a specialized function into an intermediate representation for a model-specific chipset, according to one embodiment. The method 300 illustrates one embodiment for performing block 215 in the method 200 where specialized functions are translated into IRs.

At block 305, the compiler generates a graph of the AI model code. For example, the compiler may complete a first pass of the AI model code to identify the functions (e.g., both higher-level specialized functions and the lower-level AI framework functions) in the code. The compiler can then create a graph where the nodes of the graph represent the functions and the lines between the nodes represent the data flow between the functions.

At block 310, the compiler identifies a specialized function in the code. That is, the compiler may be configured to recognize a plurality of predefined specialized functions. For example, when developing the compiler, the hardware platform provider can configure the compiler to recognize a fixed set of specialized functions.

At block 315, the compiler identifies arguments for the corresponding IR command of the identified specialized function. The value of the arguments in the IR can provide information for configuring the fused kernels corresponding to the specialized functions on the model-specific chipset. To illustrate, FIG. 4 illustrates a portion of an exemplary IR specification 400, according to one embodiment. The IR specification 400 includes a matrix multiplication section 405 and an attention section 425. The IR specification 400 is a specific example of a specification that can be used with a transformer model where each function is defined either as a matrix multiplication operation or an attention operation. An IR specification 400 for a different type of model may have different sections than what is shown in FIG. 4.

The IR specification 400 illustrates different arguments for the matrix multiplication section 405. These arguments include preprocessor arguments 410, systolic array arguments 415, and post-processor arguments 420. The preprocessor arguments 410 include arguments used to configure the model-specific chipset to perform the matrix multiplication operation. As non-limiting examples, the arguments 410 can include the memory address of a bias vector (pre_bias_addr), the memory address of a scale vector (pre_scale_addr), and a Boolean value determining whether layernorm was applied in the previous layer (norm_on argument). These are just a few of the examples of preprocessor arguments 410 that may be used when translating a specialized function into an IR.

The systolic array arguments 415 can include arguments used to configure a systolic array in the chipset to perform the matrix multiplication. These arguments 415 can include a memory address of a weight matrix (weight_addr), a length of the input (in_features), and a length of the output (out_features). These are just a few of the examples of systolic array arguments 415 that may be used when translating a specialized function into an IR.

The post-processing arguments 420 configure the chipset to prepare for the next operation after the matrix operation has completed. These arguments 420 can include memory address of the bias vector after the matrix multiplication is complete (post_bias_addr), the memory address of a scale vector after the matrix multiplication is complete (post_scale_addr), determining whether an activation function is performed after the matrix multiplication is complete (act_on), determining whether Rotary Positional Embedding (RoPE) is used (rope_on), determine whether a Gated Linear Unit (GLU) variant is used (glu_on). These are just a few of the examples of post-processing arguments 420 that may be used when translating a specialized function into an IR.

The IR indicates the values of the arguments 410, 415, and 420 for each of the specialized functions. That is, the value of the arguments 410, 415, and 420 may be different for different ones of the specialized arguments. For example, for a first specialized function, an activation may not be performed after the matrix multiplication. In that case, the IR includes a value of “zero” for act_on in the post-processing arguments 420. However, a second specialized function may perform an activation after matrix multiplication in which case its IR indicates a value of “one” for act_on. The compiler can use the AI model code to identify the values of the arguments 410, 415, and 420 (e.g., memory addresses, lengths on input/output data, whether RoPE or GLU is used, and so forth). Once the values of the arguments 410, 415, and 420 are identified, this creates an IR for the specialized function.

Moreover, some of the specialized functions may not include all of the arguments 410, 415, and 420 in the specification 400. For example, if a specialized function does not use RoPE, then the value of the rope_on parameter in its IR may be null, or be omitted. In this manner, the IR contains the values of the arguments and parameters in the IR specification 400 for a particular specialized function.

At block 320, the compiler determines whether there are post-processing arguments in the IR. These arguments may be set by values in the AI model code that are after the specialized function in the code. For example, to determine whether an activation follows the matrix multiplication, the compiler may have to crawl through later lines in the AI software code.

If the identified specialized function has post-processor arguments, the compiler may set those as null or unknown in the IR at block 315. The method then proceeds to block 325 where the compiler crawls through the graph to identify the postprocessor arguments for the specialized function based on later operations. In that case, the values of the pre-processor arguments and the systolic array arguments for a specialized function may be set at block 315, but the values of the pre-processor arguments for that specialized function may be set at block 325 after the compiler has crawled through later portions of the graph. As such, the values in the IR for a specialized function may be established in multiple steps as the compiler crawls through the graph of the AI software code.

However, if a particular specialized function does not have post-processing arguments in its IR, the method 300 can instead return to block 310 where the compiler crawls through the graph to identify another specialized function. In this manner, the method 300 can repeat until the compiler has identified all the specialized functions in the code and generated IRs for those functions.

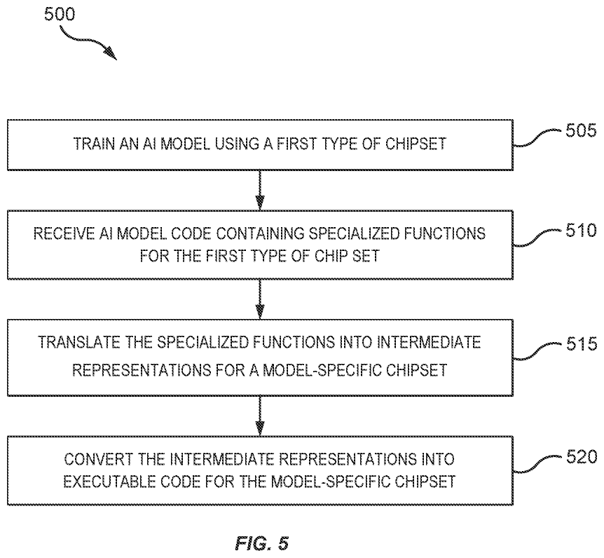

FIG. 5 is a flowchart of a method 500 for translating specialized functions for a first-type of chipset into executable code for a model-specific chipset, according to one embodiment. At block 505, an AI model is trained using a first type of chipset. In one embodiment, the chipset includes one or more CPUs or GPUs that train the AI model. Moreover, the chipset may be capable of training (or executing) different types of AI models. That is, the chipset may not be a model-specific chipset.

In one embodiment, the chipset uses one or more fused kernels to train the AI model. These fused kernels can correspond to specialized functions in the AI model code that are a combination of different types of AI framework functions. The specialized functions may execute the underlying AI framework functions sequentially, and in a defined order. Advantageously, the fused kernel can execute the different functions without having to perform read and writes to memory. Thus, the functions can be executed more efficiently relative to assigning a separate kernel to each of the AI framework functions in the specialized function.

At block 510, a compiler receives AI model code containing specialized functions for the first type of chipset. For example, the specialized functions may have been defined by a first hardware platform provider who manufactures the first type of chipset. However, the compiler may be developed by a second hardware platform provider so that the specialized functions can be used to execute the AI model in a model-specific chipset.

At block 515, the compiler translates the specialized functions into IRs for the model-specific chipset. This was discussed in detail in FIGS. 3 and 4.

At block 520, the compiler converts the IRs into executable code for the model-specific chipset. The executable code can then be loaded on the model-specific chipset and used to execute the AI model on the chipset—i.e., perform inference. In this manner, specialized functions that may be have been developed for a first type of chipset can be used in a second type of chipset (e.g., a model-specific chipset).

Further, the compiler may support the specialized functions and a handful of other lower-level AI framework functions (e.g., the dropout function). (Note that the dropout function may be used when training an AI model, and thus, might not be implemented in a compiler for a hardware platform that performs only inference.) Because some models, like transformer models, use only a handful of operations, these operations can be primarily represented by specialized functions which then can be implemented by fused kernels in the model-specific chipset, thereby improve performance when executing the AI model.

FIG. 6 illustrates an IC 600 with a systolic array 605 and a self-attention circuit 610, according to one embodiment. The IC 600 is one example of an IC in a model-specific chipset as discussed in FIGS. 1-5. For example, the IC 600 may be a transformer model IC that can execute only transformer models.

In this example, the IC 600 is coupled to a host 601 which can be a computing device (e.g., a server) or multiple computing devices. For example, the system may be deployed in a cloud computing data center with multiple hosts 601 (e.g., multiple computing devices) and multiple instances of the IC 600. In one embodiment, the host 601 and the IC 600 are disposed in the same form factor, but this is not a requirement.

Although not shown, the host 601 can include multiple processors (e.g., central processing units (CPUs) and memory. For example, the host 601 may execute an operating system that communicates with the IC 600 using the PCIe connections. In one embodiment, the IC 600 is part of an accelerator such as a ML/AI accelerator. In one embodiment, the host 601 executes a software program that offloads AI/ML tasks to the IC 600 as part of inference and receives the results from executing those tasks on the systolic array 605 and the self-attention circuit 610. In one embodiment, the host 601 can communicate with (e.g., offload task to) multiple, different AI accelerators which may be optimized for different AI models.

The IC 600 includes an embedded processor 620 that receives executable code for the AI model (e.g., a transformer model)—e.g., the executable code discussed in FIGS. 1-5. The code instructs the embedded processor 620 to configure the hardware in the IC 600 to implement the fused kernels discussed above.

The host 601 can use any other suitable interconnect to transmit data to, and receive data from, the systolic array 605. In one example, the host 601 transmits data to a leftmost column of the systolic array 605 in the IC 600 to start a task for an application (e.g., an AI application) executing on the host 601. When the IC 600 is used as an AI accelerator for a language model, an application on the host 601 can submit an embedding vector corresponding to a piece of data (e.g., a group of characters, an embedding of a part of an image, or metadata) to the leftmost column of the systolic array 605. While the connections between the host 601 and the IC 600 can be used to load data into the systolic array 605, in one embodiment, the systolic array 605 does not take instructions at runtime, and only executes instructions in a preset loop.

In one embodiment, the systolic array 605 includes rows and columns of DPUs. As such, the systolic array 605 can perform different operations for a single layer in an AI model, or perform operations for different layers in the AI model, simultaneously.

In this example, the systolic array 605 is coupled to two memory devices—memory device 615A and 615B. In one embodiment, the memory devices 615 are High Bandwidth Memories (HBMs), but this is not a requirement. When used in an AI accelerator application, the memory devices 615A and 615B can store the weights for the AI model being used at runtime. The weights can be provided by the memory devices 615A and 615B to a top row of DPUs in the systolic array 605 where the weights are passed down through the rows of the systolic array 605. In one embodiment, the weights are constant when executing the systolic array 605. Nonetheless, although not shown, the system may include additional connections between the memory devices 615A and 615B and the host 601 so that an application on the host 601 can update the data (e.g., weights) stored in the memory devices 615A and 615B. Although FIG. 6 illustrates connecting two memory devices to the systolic array 605, one, three, four, etc. memory devices can be connected to the array 605.

The self-attention circuit 610 may be specialized circuitry to perform accelerator functions that are not efficiently performed by the systolic array 605. As a non-limiting example, for AI accelerators, self-attention operations use data computed from previous tokens, which means such data should be saved. Most of the parts of a transformer model do not use data from previous tokens (i.e., previous data sequences), and thus, can be calculated efficiently using the systolic array 605 which may consider each token in isolation from the other tokens being computed on. However, for operations that do use previous data computed from previous tokens, these operations can be delegated to the self-attention circuit 610. For example, a self-attention operation may require each row of a token to be multiplied by a different matrix where the different matrix is determined by data computed from previous tokens.

The self-attention circuit 610 is not limited to any particular type of circuit. Indeed, the function of the self-attention circuit 610 may change depending on the type of AI model being executed on the accelerator device. In one embodiment, the self-attention circuit 610 could be a separate systolic array (which has access to its own memory devices 615C and 615D), or could be a different type of processing element (e.g., a micro-processor, a controller, an arithmetic-logic unit (ALU), and the like).

As shown, the self-attention circuit 610 is coupled to the memory devices 615C and 615D (e.g., one or more HBMs). In other examples, the self-attention circuit 610 can be coupled to as many memory devices 615 as needed to complete the specific attention operation, or is permitted by packaging techniques. Because there are many different types of self-attention algorithms, each with their own memory capacity and bandwidth requirements, attaching the self-attention circuit 610 to as many memory devices 615 as possible can enable the accelerator device to support a greater number of such algorithms. For example, the self-attention circuit 610 could be coupled to memory devices disposed on multiple sides of the IC 600.

In one embodiment, the memory devices 615 are connected to the ICs 600 through a substrate, such as an interposer. Alternatively, the memory devices 615 can be stacked directly on the IC 600. For example, HBMs are themselves a stack of DRAM dies with an optional base die. The DRAM dies in the HBMs can be interconnected by through-silicon vias (TSVs) and microbumps. The HBMs can be disposed on the IC 600 directly and connect to the IC 600 using microbumps.

An HBM3 module is composed of 16 different channels that can operate completely independently. In one embodiment, of portion of those channels are dedicated for storing weights used by the systolic array 605 while other channels are used for some other purpose, such as memory for the self-attention circuit 610.

Further, in some embodiments, the memory devices 615A and 615B for the systolic array 605 may not be needed. Instead, the host 601 can provide the input data and weight data for both the X direction (e.g., by providing data to the leftmost column of the systolic array 605) and the Y direction (e.g., by providing weight data to the topmost row of the systolic array 605) using, e.g., the PCIe connections.

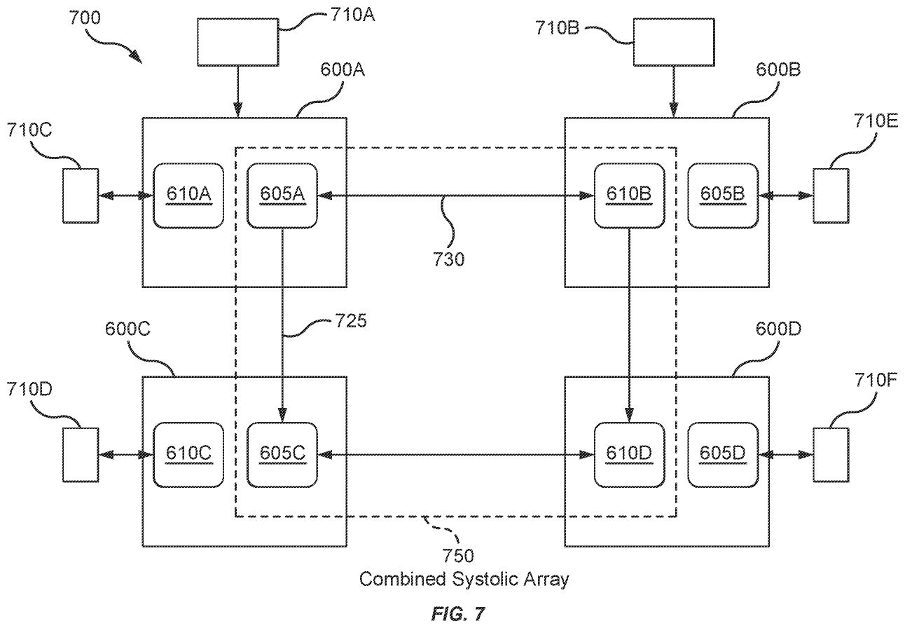

FIG. 7 illustrates a package 700 with a combined systolic array formed using a plurality of ICs 600, according to one embodiment. The package 700 is one example of a model-specific chipset as discussed in FIGS. 1-5. For example, the package 700 (and the plurality of ICs 600 in the package 700) may be able to execute only transformer models.

FIG. 7 illustrates four ICs 600A-D which each includes a systolic array 605A-D and a self-attention circuit 610A-D which were described in FIG. 6. In this embodiment, the local systolic arrays 605 in the ICs 600 are combined to form a larger, combined systolic array 750. For example, from the perspective of the host, the systolic array 750 appears to be one large array, even though it is physically made up of smaller local systolic arrays 605 distributed on separate ICs 600. In one embodiment, the ICs 600 are all identical.

The local systolic arrays 605 can be interconnected using horizontal and vertical chip-to-chip connections 725 and 730. In one embodiment, the horizontal connections 730 are bidirectional which permits data to flow from left to right and from right to left, while the vertical connections 725 are unidirectional which permits data to flow only from top to bottom (not from bottom to top). The chip-to-chip connections 725 and 730 are not limited to any particular type of connection, so long as the connection permits the flow of data between the local systolic arrays 605 so that the DPUs can output data each clock cycle. In one embodiment, Universal Chiplet Interconnect Express (UCIe) can be used to form the chip-to-chip (or die-to-die) connections 725 and 730, which has a physical layer that supports up to 32 GT/s with 16 to 64 lanes.

Further, the top row of the ICs (i.e., IC 600A and 600B) can be connected to memory chips 710. While FIG. 7 illustrates connecting the ICs 600 in the top row to one memory chip 710, they can be connected to any number of memory chips 710.

As shown, the self-attention circuits 610 in each IC 600 is coupled to at least one local memory chip 710 (e.g., one or more HBMs). In other examples, the self-attention circuits 610 in each of the ICs 600 can be coupled to as many local memories 710 as needed to complete the specific operation, or is permitted by packaging techniques. Because there are many different types of self-attention algorithms, each with their own memory capacity and bandwidth requirements, attaching self-attention circuits 610 to as many local memory chips 710 as possible can enable the accelerator device to support a greater number of such algorithms.

For example, four local memory chips 710 could be disposed around each IC 600—e.g., two memory chips 710 on opposite sides, or one memory chip 710 disposed on each side. Further, in one embodiment, the ICs 600 may be attached to the same number of local memory chips 710. However, in other embodiments, the ICs 600 may be coupled to different number of local memory chips 710.

In one embodiment, the local systolic arrays 605 do not have access to some of the local memory chips 710, and the self-attention circuits do not have access to some of the local memory chips 710. For example, only the self-attention circuit 610A may be able to access the local memory chip 710C, while only the systolic array 605A can access the local memory chip 710A. However, in other examples, the local systolic arrays 605 and the self-attention circuits 610 can access every memory chip connected to the IC 600. For instance, instead of (or in addition to) using local SRAM on the IC 600A, the local systolic array 605A may use the memory chip 710C as scratchpad space when performing their operations.

In one embodiment, the self-attention circuits 610 in one IC 600 cannot directly communicate with the self-attention circuits 610 in another IC 600. For example, the self-attention circuits 610 in each IC 600 may operate independently of each other. Instead, the self-attention circuits 610 in each IC 600 may interface with the local systolic array 605 on the same IC 600 in order to pass data and results to the self-attention circuits 610 in other ICs 600. Alternatively, the self-attention circuits 610 in the ICs 600 may be interconnected to each other using the horizontal and vertical chip-to-chip connections 725, 730 in a same or similar way as the local systolic arrays 605 are interconnected to form the combined systolic array 750.

In one embodiment, the package 700 may include a silicon wafer interposer or conventional PCB substrate on which the ICs 600 are disposed in grid-like pattern. The chip-to-chip connections 725 and 730 may be formed in the interposer. However, in another embodiment, the ICs 600 may be formed in a stack, rather than being disposed side-by-side as shown in FIG. 7. For example, the systolic array 750 may include just one row of the ICs 600 where the ICs 600 are stacked on top of each other. Micro bumps or copper pillars can be used to form the chip-to-chip connections directly between the ICs 600 in the stack to form a combined systolic array 750 from the local systolic arrays 605 in each of the ICs 600.

In one embodiment, the bandwidth of the connection of the horizontal chip-to-chip connections 730 is different for data flowing from left to right relative to data flowing from right to left. In one example, the connections 730 may provide much higher data rates for data moving from left to right than the data rates for transferring data right to left. For example, the systolic array 750 may use the right to left bandwidth to return results generated by the ICs 600 in the rightmost column back to the inputs of the systolic array 750 at the ICs 600 in the leftmost column. As a non-limiting example, the left-to-right data paths in the horizontal connections 730 may support data streams of hundreds of GBs, while the right-to-left data paths in the horizontal connections 730 may support data streams of tens of GBs (or less). Furthermore, the left-to-right data paths in the horizontal connections 730 may have a fairly constant utilization while the right-to-left data paths may be bursty (e.g., used when the computation for a row vector has been completed and the resultant values are being fed back to the leftmost input column of ICs 600).

The size of the local systolic arrays 605 can vary. For example, the arrays 605 can have sizes of approximately 100-10000 rows and 100-10000 columns of DPUs. However, this can vary depending on the overall physical size of the ICs 600, the process node used to fabricate the ICs 600 (e.g., 7 nm, 10 nm, 14 nm, 22 nm, 32 nm, etc.) and the other circuitry in the ICs 600 beside the local systolic arrays 605—e.g., the size of the self-attention circuits 610.

The package 700 can include any number of the ICs 600, which can have any number of rows and columns. For example, the combined systolic array 750 may be formed from a single row of ICs 600, or from a single column of ICs 600. In that case, assuming each IC 600 has a local systolic array 605 of dimensions 100×100 (measured in terms of DPUs within the systolic arrays 605), a single row of four ICs 600 would form a 100×400 combined systolic array 750 while a single column of four ICs 600 would form a 400×100 combined systolic array 750. Different packages 700 may have different sizes of systolic arrays 750 depending on their applications (e.g., depending on the type of computation being performed). Moreover, the physical limitations of current packaging techniques and IC technology may limit the number of ICs 600 that can be disposed in the same package 700.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving artificial intelligence (AI) model code containing a specialized function for a first one or more types of hardware platforms; and
converting, by a compiler, the specialized function into executable code for a second type of hardware platform.

2. The method of claim 1, wherein the first one or more types of hardware platforms are capable of executing different types of AI models, and the second type of hardware platform is optimized for only one type of AI model.

3. The method of claim 2, wherein the first one or more types of hardware platforms comprise at least one of a central processing unit (CPU) or a graphics processing unit (GPU).

4. The method of claim 2, wherein the second type of hardware platform comprises a model-specific chipset is optimized to execute only transformer models.

5. The method of claim 4, further comprising:
training a transformer model defined in the AI model code using the first one or more types of hardware platforms; and
performing inference using the trained transformer model on the model-specific chipset.

6. The method of claim 1, wherein the specialized function, when compiled, results in a fused kernel in the first and second type of hardware platforms.

7. The method of claim 6, wherein the specialized function comprises a plurality of lower-level functions defined by a machine learning (ML) or AI framework that are executed sequentially by the fused kernel.

8. The method of claim 7, wherein converting the specialized function into the executable code further comprises:
translating, by the compiler, the specialized function into an intermediate representation (IR); and
converting the IR into the executable code, wherein the IR comprises values of arguments that configure the second type of hardware platform to perform the plurality of lower-level functions defined in the specialized function.

9. The method of claim 1, wherein converting the specialized function into the executable code further comprises:
translating, by the compiler, the specialized function into an IR; and
converting the IR into the executable code, wherein the IR comprises values of arguments for performing at least one of matrix multiplication or attention operations on the second type of hardware platform.

10. The method of claim 1, wherein the compiler supports a plurality of specialized functions for the first one or more types of hardware platforms but supports only a limited number of lower-level functions of an ML or AI framework.

11. A non-transitory computer readable medium having program instructions embodied therewith, the program instructions executable by a processor to perform an operation, the operation comprising:
receiving AI model code containing a specialized function for a one or more types of hardware platforms;
translating, by a compiler, the specialized function into an IR; and
converting, by the compiler, the IR into executable code for a second type of hardware platform.

12. The non-transitory computer readable medium of claim 11, wherein the first one or more types of hardware platforms are capable of executing different types of AI models, and the second type of hardware platform is optimized for only one type of AI model, wherein the first one or more types of hardware platforms comprise at least one of a CPU or a GPU.

13. The non-transitory computer readable medium of claim 11, wherein the first one or more types of hardware platforms are capable of executing different types of AI models, and wherein the second type of hardware platform comprises a model-specific chipset that is optimized to execute only transformer models.

14. The non-transitory computer readable medium of claim 13, wherein the operation further comprises:
training a transformer model defined in the AI model code using the first one or more types of hardware platforms; and
performing inference using the trained transformer model on the model-specific chipset.

15. The non-transitory computer readable medium of claim 11, wherein the specialized function, when compiled, results in a fused kernel in the first and second type of hardware platforms, wherein the specialized function comprises a plurality of lower-level functions defined by a ML or AI framework that are executed sequentially by the fused kernel.

16. The non-transitory computer readable medium of claim 15, wherein the IR comprises values of arguments that configure the second type of hardware platform to perform the plurality of lower-level functions defined in the specialized function.

17. A system, comprising:
one or more processors; and
memory storing a compiler which, when executed by the one or more processors, performs an operation comprising:
receiving AI model code containing a specialized function for a first one or more types of hardware platforms;
translating the specialized function into an IR; and
converting the IR into executable code for a second type of hardware platform.

18. The system of claim 17, wherein the first one or more types of hardware platforms are capable of executing different types of AI models, and the second type of hardware platform is optimized for only one type of AI model, wherein the first one or more types of hardware platforms comprise at least one of a CPU or a GPU.

19. The system of claim 17, wherein the first one or more types of hardware platforms are capable of executing different types of AI models, and wherein the second type of hardware platform comprises a model-specific chipset that is optimized to execute only transformer models.

20. The system of claim 19, wherein the operation further comprises:
training a transformer model defined in the AI model code using the first one or more types of hardware platforms; and
performing inference using the trained transformer model on the model-specific chipset.
